(19) United States
(12) Patent Application Publication
(10) Pub. No.: US 2025/0036186 A1
(43) Pub. Date: Jan. 30, 2025

(54) Method and system for power management and scheduling based on human interface device input type

(71) Applicant: Intel Corporation, Santa Clara, CA (US)

(72) Inventors: Venkateshan UDHAYAN, Portland, OR (US); Chia-Hung S. KUO, Folsom, CA (US); Antonio S. CHENG, Portland, OR (US); Lawrence FALKENSTEIN, Beaverton, OR (US); Swetha KARLAPUDI, Portland, OR (US); Brian WILK, Portland, OR (US); Michael SHUSTERMAN, Portland, OR (US); Deepak Samuel KIRUBAKARAN, Hillsboro, OR (US); Rajshree CHABUKSWAR, Sunnyvale, CA (US)

(21) Appl. No.: 18/919,509

(22) Filed: Oct. 18, 2024

(51) Int. Cl. G06F 1/3228; G06F 9/48

(52) U.S. Cl. CPC G06F 1/3228; G06F 9/4881

(57) ABSTRACT

A method and system for power management and scheduling based on human interface device (HID) input types. A user input is received via an HID, and an HID input type of the user input is determined. The HID input type is then provided to a power management controller and/or an operating system scheduler, and power management and/or scheduling are performed based on the HID input type. An operating frequency of a processor or a processor core of the system may be adjusted based on the HID input type. One of the processor cores in a hybrid system such as a P-core or an E-core may be selected for a task based on the HID input type.

### BACKGROUND

Users interact with a computing system with a human interface device (HID). The ways to interact with the computing system have changed over time. Users can interact with the computing system in numerous different ways. Currently in a hybrid computing system, an HID device input type is not considered by power management hardware or an operating system (OS) scheduler in a central processing unit (CPU) compute decision. When users interact with a system, such as through an HID, the power consumption of a system on chip (SoC) and an overall platform typically increases. Continuous user inputs, such as moving a mouse or using a trackpad, generate a higher rate of interrupts to the CPU compared to keyboard inputs. Scheduling to high power CPU cores in response to an HID input guarantees best possible responsiveness. However, not all HID input situations benefit from such aggressive bias toward performance at the expense of power efficiency.

### BRIEF DESCRIPTION OF THE FIGURES

Some examples of apparatuses and/or methods will be described in the following by way of example only, and with reference to the accompanying figures, in which

FIG. 1A is a block diagram of an example system for power management and OS scheduling based on an HID input type;

FIG. 1B shows an example system for implementing power management and scheduling based on the HID input types;

FIG. 1C shows an example system configured for implementing power management and scheduling based on the HID input types;

FIG. 2 shows an example of high-level flow of human interaction with applications;

FIG. 3 shows an example scheme of allocating a compute die in a hybrid system based on HID input types;

FIG. 4 is a block diagram of an example system for implementing power management and/or scheduling based on user interaction types;

FIG. 5 is a flow diagram of an example process for power management and scheduling based on HID input types;

FIG. 6 shows web browser HID modalities duty cycle for cursor navigation, scrolling, and other interactions;

FIG. 7 shows office productivity application HID modalities duty cycle;

FIGS. 8A and 8B show CPU utilization traces from the experiment without and with implementing the method of power management and scheduling based on HID input types, respectively;

FIG. 9 is a block diagram of an electronic apparatus incorporating at least one electronic assembly and/or method described herein;

FIG. 10 illustrates a computing device in accordance with one implementation of the invention; and

FIG. 11 shows an example of a higher-level device application for the disclosed embodiments.

### DETAILED DESCRIPTION

Various examples will now be described more fully with reference to the accompanying drawings in which some examples are illustrated. In the figures, the thicknesses of lines, layers and/or regions may be exaggerated for clarity.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Like numbers refer to like or similar elements throughout the description of the figures, which may be implemented identically or in modified form when compared to one another while providing for the same or a similar functionality.

It will be understood that when an element is referred to as being “connected” or “coupled” to another element, the elements may be directly connected or coupled or via one or more intervening elements. If two elements A and B are combined using an “or”, this is to be understood to disclose all possible combinations, i.e. only A, only B as well as A and B. An alternative wording for the same combinations is “at least one of A and B”. The same applies for combinations of more than 2 elements.

The terminology used herein for the purpose of describing particular examples is not intended to be limiting for further examples. Whenever a singular form such as “a,” “an” and “the” is used and using only a single element is neither explicitly or implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises,” “comprising,” “includes” and/or “including,” when used, specify the presence of the stated features, integers, steps, operations, processes, acts, elements and/or components, but do not preclude the presence or addition of one or more other features, integers, steps, operations, processes, acts, elements, components and/or any group thereof.

Unless otherwise defined, all terms (including technical and scientific terms) are used herein in their ordinary meaning of the art to which the examples belong.

In the following description, specific details are set forth, but examples of the technologies described herein may be practiced without these specific details. Well-known circuits, structures, and techniques have not been shown in detail to avoid obscuring an understanding of this description. “An example,” “various examples,” “some examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform or resource, even though the instructions contained in the software or firmware are not actively being executed by the system, device, platform, or resource.

The description may use the phrases “in an example,” “in examples,” “in some examples,” and/or “in various examples,” each of which may refer to one or more of the same or different examples. Furthermore, the terms “comprising,” “including,” “having,” and the like, as used with respect to examples of the present disclosure, are synonymous.

Hereafter, example schemes for power management and OS scheduling based on HID input types are disclosed. The example schemes disclosed herein address how to balance energy efficient computing versus performance computing based on HID input types. It should be noted that some details below are specific to Bluetooth-based HID, but the scope is not limited to Bluetooth-based HID but encompasses all forms of human interactions, including gestures, facial actions, speech inputs, and data from various devices (e.g., trackpad, sensors, touch screen, or the like).

The increasing demand for advanced functionalities in computers (e.g., an artificial intelligence (AI) assistance or any computers) and application capabilities necessitates power optimization and battery life improvement. In example schemes disclosed herein, advanced functionalities are integrated into the power management and scheduling algorithms, which act as the pivotal element within a system (e.g., a hybrid system including multiple processor chips or processor cores). As computers evolve to act more like personal assistants, user interaction with a system intensifies. This is particularly true for segments like creators, gamers, and office productivity users, who frequently engage in tasks that require extensive human computer interactions, such as cursor navigation, scrolling, gesture-based application control, etc. Integrating the advanced capabilities in accordance with the example schemes disclosed herein will lead to more effective battery life management. Enhanced hardware signaling will significantly aid the operating system in determining the most efficient operational configurations, and the like.

The industry lacks a benchmark that accounts for HID inputs/interrupts and driver activity within the workflow. Consequently, the influence of HID activities on power consumption and performance is overlooked in current benchmarks. The challenge is compounded by the platform power management controller's lack of direct information on user input types while interacting with the computer and the absence of an established HID interrupt classification model. Microcontrollers responsible for power management algorithms play a key role in this, as they coordinate the power usage across various chips in a PC, helping to balance performance with energy efficiency.

In the current landscape, the Advanced Programmable Interrupt Controller (APIC) and the operating system (OS) predominantly receive the HID data set. In example schemes disclosed herein, by leveraging the additional HID classification (HID input type), a hardware inference is constructed that refines power management decisions for a system on chip (SoC). This, in turn, provides nuanced feedback to the OS for enhanced power control.

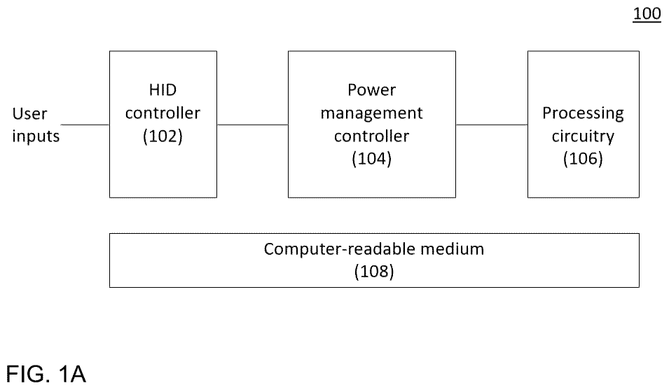

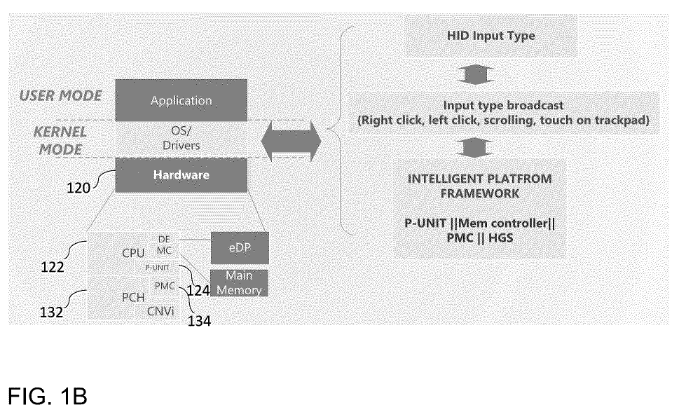

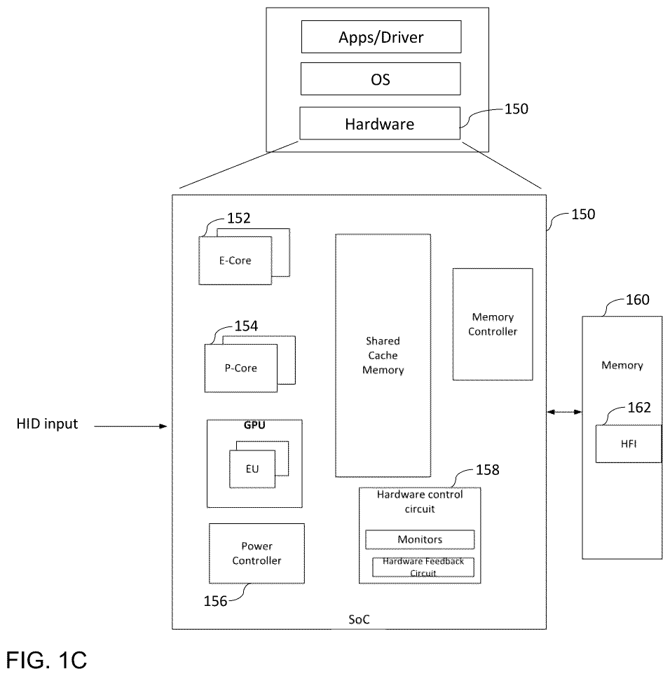

FIG. 1A is a block diagram of an example system 100 for power management and OS scheduling based on an HID input type (user interaction type). The example system 100 includes an HID controller 102, a power management controller 104, and processing circuitry 106.

The HID controller 102 is a device or component that facilitates communication between a human interface device (HID) and a computer/system. An HID is a class of devices that interact directly with humans and are used to input data into a computer/system. The HID standard was created to simplify the process of connecting devices like keyboards, mice, and other input/output devices to computers. The HID controller 102 interprets inputs from the physical interface (e.g., key presses, mouse movements, etc.) and translates them into a format that the computer/system can understand and respond to. This involves managing the communication between the input/output device and the operating system (OS). The HID controller 102 acts as an intermediary between the hardware of an input/output device and the software on a computer/system. The HID controller 102 is configured to receive a user input via an HID. The HID may be any input/output devices, such as a mouse, a keyboard, a joystick, a trackpad, a touch screen, sensors, speech-based input/output devices, gesture-based input devices (e.g., facial or hand gesture), or the like.

The power management controller 104 manages power consumption and efficiency across various parts of the system. The power management controller 104 helps manage the different power states of the processor, such as C-states (idle states), P-states (performance states), and S-states (sleep states). The power management controller 104 ensures that the processing circuitry 106 operates in the most efficient power state based on current workload requirements, which helps in reducing power consumption and extending battery life in portable devices. The power management controller 104 monitors the temperature of the processing circuitry 106 and other system components. If the temperature exceeds certain thresholds, the power management controller 104 can throttle the processor's speed or activate cooling mechanisms to prevent overheating. The power management controller 104 can selectively power down certain parts of the processing circuitry 106 or other components when they are not in use (i.e., power gating). This helps in saving energy by turning off parts of the chip that are not needed at a given time. The power management controller 104 can adjust the clock speeds of different components to match performance needs. By dynamically scaling down clock speeds when full performance is not required, the power management controller 104 helps reduce power consumption. The power management controller 104 can also manage and adjust the voltage supplied to various components, ensuring that they operate efficiently under different conditions. Lowering the voltage when possible helps in reducing power consumption and heat generation. The power management controller 104 also manages wake-up events, such as when the system needs to come out of a low-power state (e.g., a sleep mode) due to user input or other triggers. It ensures that the system can quickly and efficiently return to a fully operational state.

The processing circuitry 106 may be in a hybrid architecture including at least two different types of processing cores (e.g., high-performance cores (P-cores) and efficiency cores (E-cores)). Processors in hybrid architecture utilize a combination of P-cores and E-cores that collaborate efficiently. The P-core is designed for high-performance tasks. The P-core is optimized to handle demanding workloads that require more computational power. The E-core is designed to handle lighter, routine tasks focusing on energy conservation. The primary aim of the hybrid processor architecture is to ensure that the system remains responsive and efficient, even when it is not being pushed to its limits. The E-cores consume less power and produce less heat. The E-core design ensures that the processor can function efficiently for many everyday tasks without drawing unnecessary power or generating excessive heat. While P-cores are focused on delivering peak performance for intensive workloads, E-cores ensure that the system runs efficiently during regular use. The synergy between P-cores and E-cores allows the processor to adapt dynamically to varying workloads, balancing power and performance. The P-core(s) and the E-core(s) may be in a single chip, in different chips, or in different packages. An OS including an OS scheduler runs on the processing circuitry 106. The OS scheduler is a software that schedules the processes/tasks in an operating system. The OS scheduler helps to keep all computer resources busy and allows multiple users to share system resources effectively.

In examples disclosed herein, an HID input type (user interaction type/category/classification) of the user input is determined, e.g., by the HID controller 102, and power management and/or OS scheduling are performed based on the HID input type. For example, the HID inputs, such as cursor movements, mouse clicks, joystick plots, keyboard activities, multi-axis controls, trackpad or touch screen gestures, facial or hand gestures, speech-based inputs, and the like, are analyzed and the HID input types of the user inputs are determined. As an example, some of the definitions and modalities of HID input types are as follows:
Scrolling: scrolling up/down within applications, such as PowerPoint, Word, OneNote, Excel, etc.;
Cursor movement: all navigation of a mouse cursor laid over an application;
Typing: keyboard inputs within an application, such as Outlook, OneNote, Word, etc.; and
Gesture: gestures on trackpad or touch screen or facial or hand gestures, for example, pinch and hold, pinch and drag, finger tapping, touch, etc.

It should be noted that the above HID input types are merely an example, and the list of HID input types may include additional types/categories. The above HID input types/categories may include sub-types/categories. For example, the cursor movement category may include sub-categories of mouse right click, and mouse left click, etc. In some examples, Bluetooth HID devices such as Bluetooth mice and keyboards may be utilized for user interface. In this case, the HID devices (e.g., mice and keyboards) act as slaves, while the Bluetooth controller (e.g., integrated in an SoC) acting as a master receives the HID input signals and classifies the user input type. The Bluetooth controller may then provide feedback on the input type, distinguishing between actions like “scrolling” and “user right-click.” This classification can influence hardware controller actions (e.g., P-unit and PMC) to optimize for either energy efficiency or performance. Essentially, it can manage various hardware components, such as core frequency and memory buffers, to balance power consumption and responsiveness.

The HID input types may be grouped into two different groups (group 1 and group 2). Group 1 HID input types are purely based on the human interaction with the HID peripheral capabilities. Group 1 HID input types could be discrete events, like key press, or a temporal or special sequence like gestures or patterns (physical domain). Group 2 HID input types depend on the context of the foreground application that is receiving the input (digital domain). Whether a touchpad gesture is translated to a cursor movement, a page scroll action, or nothing is application context dependent. Solution for power management and scheduling based on group 1 HID input context only can be realized by hardware, and solution for power management and scheduling that depends on both group 1 and group 2 HID input types are more robust but more complex.

The system 100 also includes a computer-readable medium 108. The computer-readable medium 108 includes a program code (e.g., machine learning algorithm code) that, when the program code is executed on a processor, a computer, or a programmable hardware component (in the HID controller 102, the power management controller 104, and the processing circuitry 106), causes the processor, the computer, or the programmable hardware component to perform the methods as disclosed herein. For example, the program code is to receive a user input from an HID, determine an HID input type of the user input, provide the HID input type to a power management controller and/or an OS scheduler, and perform power management and/or scheduling based on the HID input type. The program code may be further to adjust an operating frequency of the one or more processor cores based on the HID input type. The system is a hybrid system including two or more different types of processor cores and the program code may be to select one of the two or more different types of processor cores for a task based on the HID input type. The system includes at least one performance core (P-core) and at least one energy efficiency core (E-core) and the program code may be to select a P-core or an E-core for the task depending on the HID input type. The program code may be to set an energy performance preference (EPP) value for the system, System Agent Geyserville (SAGV) frequency setting, operating frequency of a memory, and/or allocation of memory units based on the HID input type. The program code may be to update a hardware feedback interface table based on the HID input type. The program code may be to park one or more processor cores in the system based on the HID input type. The program code may be to determine whether a class of service 0 residency is lower than a threshold and/or whether a core concurrency is lower than an E-core count and perform the power management and/or scheduling based on the HID input type if the class of service 0 residency is lower than the threshold and/or the core concurrency is lower than the E-core count.

FIG. 1B shows an example system for implementing power management and scheduling based on the HID input types. The OS and driver run on the platform hardware 120 that may include a CPU 122 and a platform controller hub (PCH) 132, a memory, etc. The CPU 122 may include an internal power controller (P-unit) 124 for the CPU power management. The PCH 132 controls certain data paths and support functions used in conjunction with the CPU 122. The power management controller (PMC) 134 in the PCH 132 may handle all power management-related activities. The HID inputs from the user are received and classified, for example by the Bluetooth controller (master) integrated within the system (SoC). The HID input type (e.g., mouse right click, mouse left click, scrolling, touch gesture on a trackpad, etc.) is sent to the OS, the P-unit 124, and the PMC 134 for power management and OS scheduling.

FIG. 1C shows an example system configured for implementing power management and scheduling based on the HID input types. The example system includes an SoC 150 and a memory 160 that may include an hardware feedback interface table 162. The SoC 150 may include a plurality of different types of processing cores, such as E-core(s) 152 and P-core(s) 154 and cache memory, a memory controller, a GPU, a power controller 156, hardware control circuit 158 including hardware feedback circuit, etc. The OS and driver run on the SoC 150. The HID input data may be received and processed by the HID controller (not shown) that may be integrated in the SoC 150. The HID inputs, such as cursor movements, mouse clicks, joystick plots, keyboard activities, multi-axis controls, trackpad or touch screen gestures, facial or hand gestures, speech-based inputs, and the like, are analyzed, e.g., by the Bluetooth controller that may be integrated in the SoC 150, and the HID input types of the user inputs are determined and sent to the OS and power management hardware, such as a P-unit in a CPU or a PMC in a PCH.

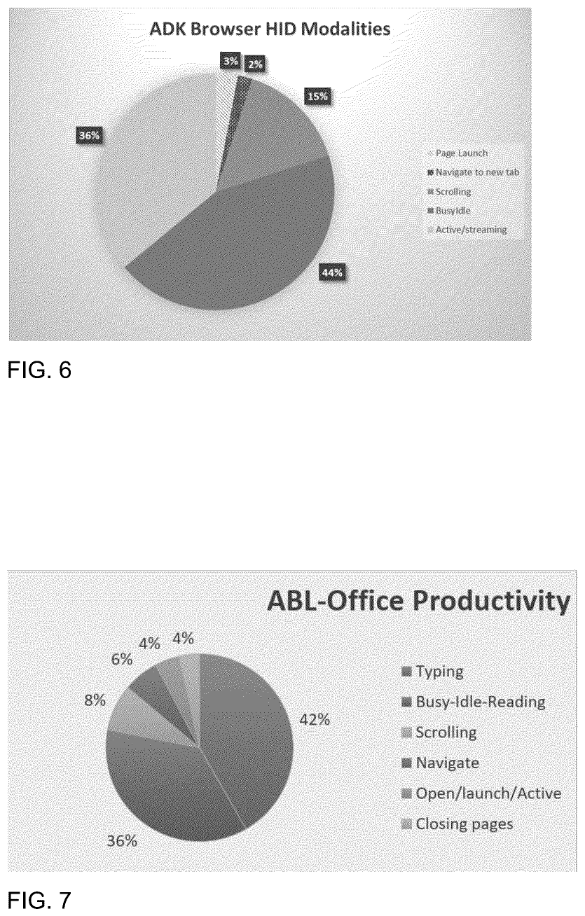

The definitions and modalities of user interactions in the list above are based on the analysis of user interactions shown in FIGS. 6 and 7. It should be noted that the list above is merely an example, not a limitation, and the HID input types may be defined differently.

The HID input type determined from the user input is provided to the power management controller 104 and/or the OS scheduler. The power management controller 104 may perform power management based on the HID input type, and the OS scheduler may also perform scheduling based on the HID input type. In examples, the power management controller 104 and the OS scheduler are configured to consider the types of HID inputs (i.e., the user interaction types) in performing power management and scheduling, respectively. In examples, a feedback loop is formed for providing the HID input types among the OS scheduler, the power management controller 104, and the HID controller 102. With the integration of this feedback loop, a power management and scheduling strategy can be developed and implemented that is both dynamic and responsive, capable of adjusting to the system's current workload, in favor of aligning with power and performance demands. For example, the HID input types (user interaction types) are informed to the power management controller 104, aiding the Hardware Guided Scheduling (HGS) by providing more accurate feedback to the OS scheduler. By analyzing the HID inputs such as cursor movements, mouse clicks, joystick plots, keyboard activities, multi-axis controls, human and trackpad/touch screen gestures, speech-based inputs, and the like, the system can better understand user actions and optimize application power and performance accordingly.

Hardware Guided Scheduling (HGS) is a technology that is a part of a hybrid CPU design. HGS works with an OS scheduler to intelligently assign tasks to the appropriate cores/processors and threads. With hardware guided scheduling, hardware provides dynamic feedback to the OS (hardware feedback interface) in the form of dynamic performance and energy efficiency capabilities of P-cores and E-cores based on power/thermal limits and idling hints when power and thermal are constrained. In processors that support hybrid architecture, all cores are exposed to the OS. The OS scheduler is responsible for determining which software threads should be scheduled on which core type.

The HID input type (i.e., feedback/hint) may be sent to the P-code (the code that is executed by the power control unit/P-unit) via software power/performance interface (SPPI) memory mapped IO (MMIO). The SPPI is a mechanism designed to manage and optimize the power and performance of computer processors. The SPPI serves as a software interface that allows the operating system, firmware, or other software components to interact with the hardware to adjust power and performance characteristics dynamically. The MMIO interface may be used to adjust the CPU's voltage and frequency in real-time. For example, writing to a specific MMIO address might lower the CPU frequency during low workloads to save power and then increase it when more performance is needed. Certain actions (e.g., throttling the CPU) may be taken by writing to performance control registers, for example to prevent overheating, etc. The MMIO interface may be used to transition the processor between different power states by writing to specific MMIO registers.

The feedback (i.e., the HID input type) is used/considered to optimize the system (e.g., a disaggregated die/heterogenous clusters) to favor either battery life (power consumption) or responsiveness (performance). For example, the feedback (i.e., the HID input type) may be used to optimize the power efficiency and performance (i.e., balance between the power efficiency and performance) via memory control knobs like System Agent Geyserville (SAGV) tuning, Energy Performance Preference (EPP), hardware feedback interface table update, operating frequency of a memory and/or allocation of memory units, etc.

SAGV is a way by which a system can dynamically scale the work point by applying Dynamic Voltage Frequency Scaling (DVFS) based on memory bandwidth utilization and/or the latency requirement of the various workloads for better energy efficiency at system agent.

EPP is a setting that helps determine how aggressively the CPU should prioritize performance over power savings or vice versa. The EPP value influences how the processor's frequency and voltage are managed under different load conditions. Lower EPP value favors performance, and higher EPP value favors power.

The hardware feedback interface table is a mechanism to provide information about the performance and power characteristics of the CPU to the operating system or firmware. This interface enables more efficient power and performance management by allowing the operating system to make decisions based on real-time feedback from the hardware. The hardware feedback interface provides detailed, real-time information about the processor's capabilities, power states, thermal conditions, and performance potential. This feedback allows the operating system to optimize its power management and scheduling decisions based on the actual conditions of the hardware. The OS reads the hardware feedback interface table to make informed decisions about power and performance management. The OS may lower the CPU frequency when it detects that the workload is light, and the processor is running too hot or may boost performance when there is more thermal and power headroom available. The hardware feedback interface allows the OS to balance performance and power consumption dynamically, leading to better overall system efficiency.

Based on the user HID input context including input type, application in focus, priority of the application, performance or efficiency bias may be applied at run-time using EPP and HFI table settings that can be modified for optimal CPU operating point. Similarly, the same heuristic can be utilized by the SAGV algorithm to set appropriate SAGV frequency to favor power or performance, for example by controlling memory frequency and overall un-core settings.

Incorporating the HID input type (user interaction type) into the power management controller's logic allows for more refined power management. For example, voltage minimum (Vmin) and voltage maximum (Vmax) ranges may be set based on the HID input type classifications (user interaction types). Typically, these Vmax and Vmin values are closely tied to the specific CPU model and its operational specifications, including power management technologies and performance targets. Modern CPUs are equipped with the ability to dynamically adjust their operating voltage within the Vmin and Vmax range, influenced by various factors such as thermal conditions, power settings, and workload types. This capability is widely recognized as Dynamic Voltage and Frequency Scaling (DVFS). Efficiently managing these voltage levels is crucial for optimizing the performance-to-power consumption ratio. For instance, depending on the classification of HID inputs, the system can toggle between modes that are optimized for high-performance computing or energy-efficient operations. In other example, the OS scheduler may allocate resources for the task based on the user interaction type. Similarly, the OS scheduler can handle the process, thread prioritization, CPU utilization and load balancing, memory management and thermal optimization based on the HID input type/classification.

With this scheme, the system can enhance the efficiency of both the HGS and the OS scheduler. This approach ensures that power delivery is tailored to the user's current interaction with the device, that can lead to improvements in both performance and energy consumption.

The integration of HID input types into power management strategies enables the system to dynamically adjust power settings based on real-time user interactions. This can lead to improved energy efficiency. Tailoring power trend to the user's actions can reduce unnecessary power consumption, extending battery life. It can also lead to optimized application performance. By understanding the user's current activity, the system can allocate resources more effectively, ensuring optimal performance for the task. It can also lead to enhanced user experience. A system that responds intelligently to user inputs can provide a smoother and more responsive experience with improved user experience (UX). With the example schemes disclosed herein, hardware capabilities can be developed that are OS-agnostic, enabling the system to meet the right needs, whether it is battery life, performance, or responsiveness.

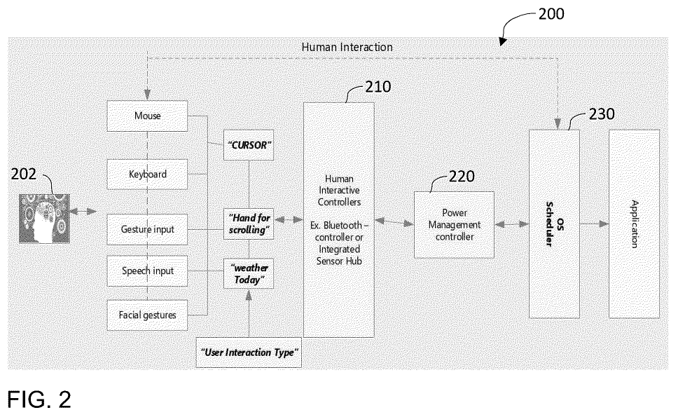

FIG. 2 shows an example of high-level flow of human interaction with applications. A user 202 interacts with the system 200 using one or more input devices (e.g., HIDs). The HID may be a mouse, a keyboard, a track pad, a touch screen, or the like, and a human speech or facial or hand gestures may be used for the input. The user input signal is sent to the HID controller 210 and the user input is analyzed to determine the user interaction type. For example, the user input may be a cursor movement, a hand gesture for scrolling, a speech input for requesting the weather today, or the like. Those user inputs are analyzed to determine the HID input types.

The HID controller 210 may be a Bluetooth controller or an integrated sensor hub, etc. A Bluetooth controller is a hardware component responsible for managing Bluetooth wireless communication. The Bluetooth controller maybe integrated into the system and enables devices to connect and communicate wirelessly with other Bluetooth-enabled devices, such as keyboards, mice, wireless headphones, and the like. An integrated sensor hub is a lower-power/always-on co-processor inside a processor. The integrated sensor hub helps offload sensor processing tasks from the core processor for better power saving. The integrated sensor hub allows the core processor to go into low power modes more often, resulting in increased battery life.

The HID input type is provided to the power management controller 220 and/or the OS scheduler 230. The power management controller 220 then performs power management based on the HID input type, and the OS scheduler 230 performs process/task scheduling based on the HID input type. In example schemes disclosed herein, a differentiated approach is used based on HID modalities (HID input types). For instance, a page launch might require a rapid response which may be executed with a performance core, followed by subsequent actions like a mouse “left click” to open a popup menu, which may be executed with a power efficiency core.

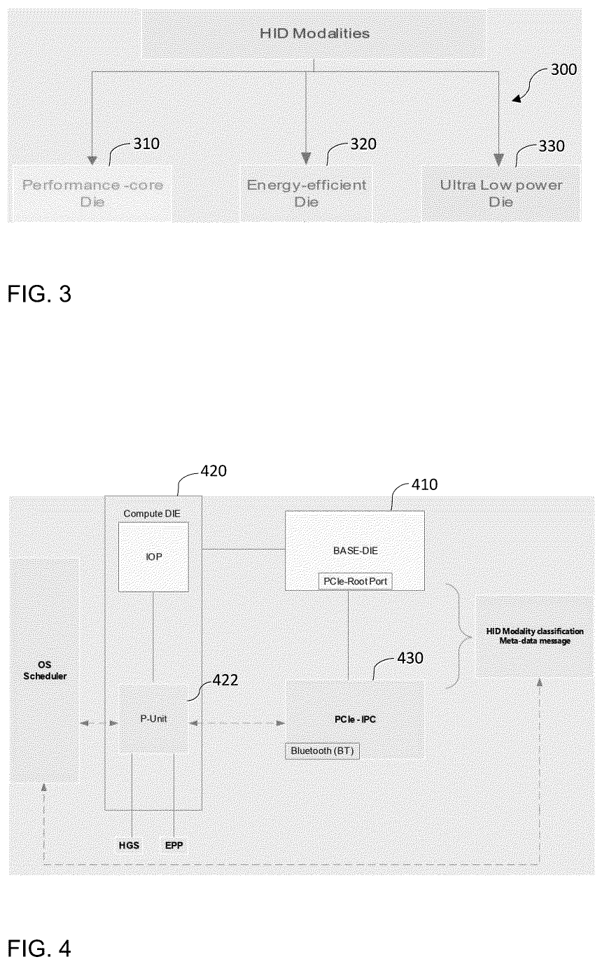

FIG. 3 shows an example scheme of allocating a compute die in a hybrid system based on HID input types (HID modalities). The system 300 may be an electronic assembly (e.g., a package) where multiple integrated circuits (chips or dies) are integrated. In this example, the system 300 includes a plurality of different types of compute dies. For example, the system 300 may include a performance die(s) 310, an energy-efficient die(s) 320, and ultra-low-power die(s) 330. It should be noted that FIG. 3 shows three different types of dies as an example, and the system 300 may include two different types of dies or more than three different types of dies. It should also be noted that the scheme can be applied to any type of processors (e.g., CPU, graphics processing unit (GPU), neural processing unit (NPU), or the like).

The user inputs via HID devices are analyzed and the HID input type (i.e., HID modalities) is determined based on the user inputs. One of the compute dies 310-330 is then selected for the task/process based on the HID input type. For example, if the HID input type is a mouse left click to launch a web page, the task may be assigned to the performance die 310, and if the user interaction type is scrolling or cursor navigation, the task may be assigned to the energy-efficient die 320 or the ultra-low-power die 330.

FIG. 4 is a block diagram of an example system for implementing power management and/or scheduling based on user interaction types. In this example, the system 400 may include a base die 410, a compute die 420, and a PCIe device 430. In this example, different functions of the system 400 are distributed across separate dies (chiplets/tiles) within a single package.

The base die 410 serves as foundation of the package, managing communication between different components, including the compute die 420, graphics processing units, memory controllers, and other integrated subsystems in the system 400 that are not shown in FIG. 4. The base die 410 may include elements such as a memory controller, PCIe lanes, power management, and other system-level interconnects. The base die 410 may act as a hub, facilitating the communication and power distribution across the various dies/tiles within the system 400.

The compute die 420 is responsible for the primary processing tasks of the system 400. The compute die 420 may include main processing cores (e.g., P-cores for performance and E-cores for efficiency in hybrid architectures) and a cache associated with these cores. The compute die 420 is optimized for delivering high-performance computing power. The compute die 420 handles the bulk of the processing workload, executing instructions, managing threads, and running applications. The compute die 420 may include an input/output processor (IOP) and a power management unit (P-unit) 422.

The HID input type information (HID modality classification meta data) may be sent through PCIe vendor-defined messages (VDMs). The PCIe device 430 may include Bluetooth circuitry for connection with the Bluetooth-based HID devices. The PCIe device 430 is connected to the PCIe root port in the base die 410. Bluetooth is compatible with the PCIe interface, hence can use the existing PCIe sideband signaling and leverages the Intelligent Platform Framework (IPF) software.

By incorporating HID input type considerations into the power management controller's functions and OS scheduling, a more perceptive and agile computing environment can be established. The example schemed disclosed herein refine power management and OS scheduling to better reflect user activity, yielding both performance gains and energy efficiency.

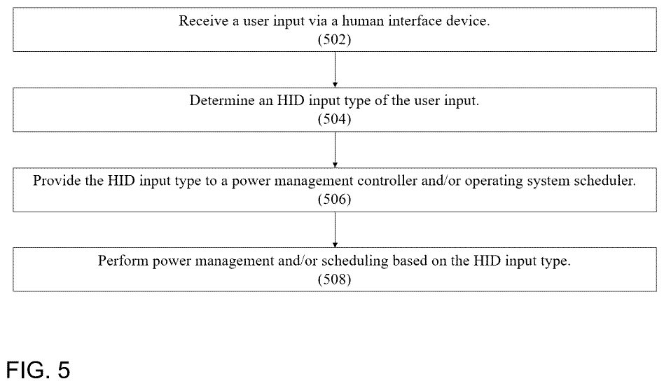

FIG. 5 is a flow diagram of an example process for power management and scheduling based on HID input types.

A user input is received via a human interface device (HID) (502). The HID may be any input/output devices, such as a mouse, a keyboard, a joystick, a trackpad, a touch screen, speech-based input/output devices, gesture-based input devices, or the like. An HID input type (user interaction type) of the user input is determined (504). For example, the user interaction type may be cursor movement, scrolling, typing, gesture, and the like. The user input may be analyzed into one of the predefined HID input types/classifications. The HID input type is provided to the power management controller and/or the OS scheduler (506). Power management and/or scheduling is then performed based on the HID input type (508). For example, it may be determined whether the HID input type nature indicates power save over responsiveness. If so, energy efficient setting may be selected, and if not, hardware may be controlled for performance operation points.

In some examples, an operating frequency of a processor or a processor core of the system may be adjusted based on the HID input type.

In some examples, the system is a hybrid system including two or more different types of processor cores and one of the processor cores may be selected for a task based on the HID input type. In some examples, the system includes at least one performance core (P-core) and at least one energy efficiency core (E-core) and the task may be assigned to a P-core or an E-core depending on the HID input type.

In some examples, an energy performance preference (EPP) value for the system, System Agent Geyserville (SAGV) frequency setting, operating frequency of a memory, and/or allocation of memory units may be selected based on the HID input type.

In some examples, a hardware feedback interface table may be updated based on the HID input type.

In some examples, one or more processor cores in the system may be parked based on the HID input type. In general, core parking is a dynamic process. Cores can be parked or unparked on-the-fly based on real-time analysis of the system's performance needs and power consumption. For example, the HID input type “left mouse click” leading to app launch event and steered toward performance/responsiveness may lead to unpark the parked core for computing needs. Similarly, a “mouse right click” for a menu pop-up not demanding more cores may lead to park cores to favor battery life.

A class of service (CLOS) refers to different levels or categories of service that can be assigned to various processes, tasks, or resources in a computing system. A CLOS allows for fine-grained control over how system resources like cache or memory bandwidth are allocated to different processes or threads. CLOS 0 is the default or base class of service. CLOS 0 represents the normal, default allocation of resources without any specific quality of service tuning or prioritization. All tasks that do not have a higher-priority class of service are generally assigned to CLOS 0. CLOS 0 residency refers to the amount of time or percentage of time that a processor or system component spends handling tasks that fall under CLOS 0. Monitoring CLOS 0 residency helps in understanding how effectively a system is using its power and performance tuning capabilities. CLOS 0 residency provides insights into whether the system is spending too much time in a default state when it could be optimized further for either power efficiency or performance, depending on the workload and user preferences.

Core concurrency refers to the number of tasks or threads that a CPU core can handle simultaneously. Core concurrency is a measure of how many threads a single CPU core can handle at the same time, and it plays a critical role in determining the performance and efficiency of processors.

In some examples, it is determined whether a class of service 0 residency is lower than a threshold (e.g., less than 100% on cores) and/or whether a core concurrency is lower than an E-core count (i.e., the work fits in E-cores), and the power management and/or scheduling may be performed based on the HID input type if the class of service 0 residency is lower than the threshold and/or the core concurrency is lower than the E-core count.

In some examples, wherein the HID input type may be indicated to the power management controller of the OS schedule via PCIe sideband signaling.

For proof of concept, a Bluetooth mouse's interaction with an SoC has been analyzed, examining how mouse-related operations influence the SoC's power usage during routine tasks such as web-browsing benchmarks and office productivity software.

FIG. 6 shows web browser HID modalities duty cycle for cursor navigation, scrolling, and other interactions (page launch, busy-idle, active/streaming). FIG. 7 shows office productivity application HID modalities duty cycle. The data presented in FIGS. 6 and 7 integrates HID estimation based on benchmark results and considers telemetry data from actual laptop usage. FIGS. 6 and 7 show guestimates derived from Microsoft benchmarks, illustrating the HID duty cycle in the workflows.

In this analysis, during a 12-hour work period, users spend approximately 30% to 50% of their time interacting with the system using HID devices, primarily through user interactions and gesture actions. These actions were particularly prevalent in workflows associated with office productivity, content creation, and gaming. Current benchmarks do not account for actual HID usage, which includes activities related to HID drivers and the operating system's host stack, both of which can increase SoC power consumption.

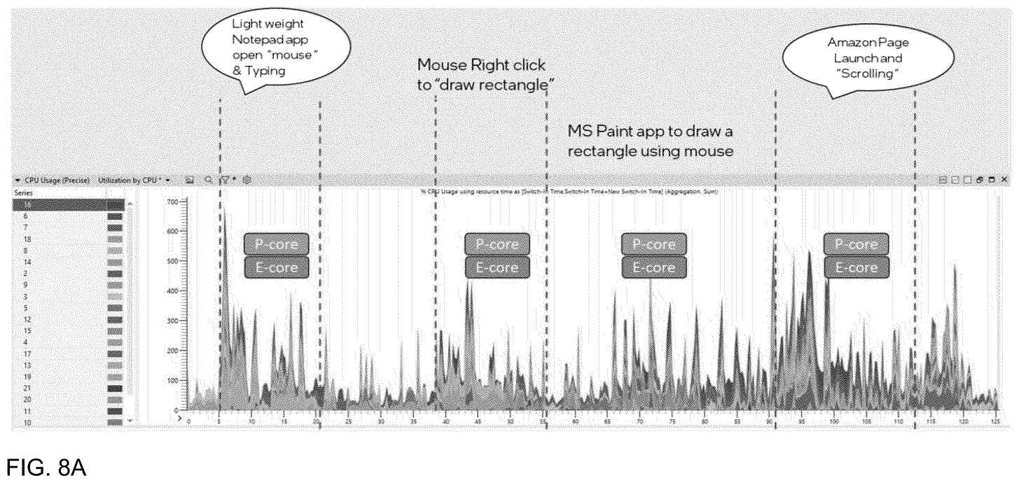

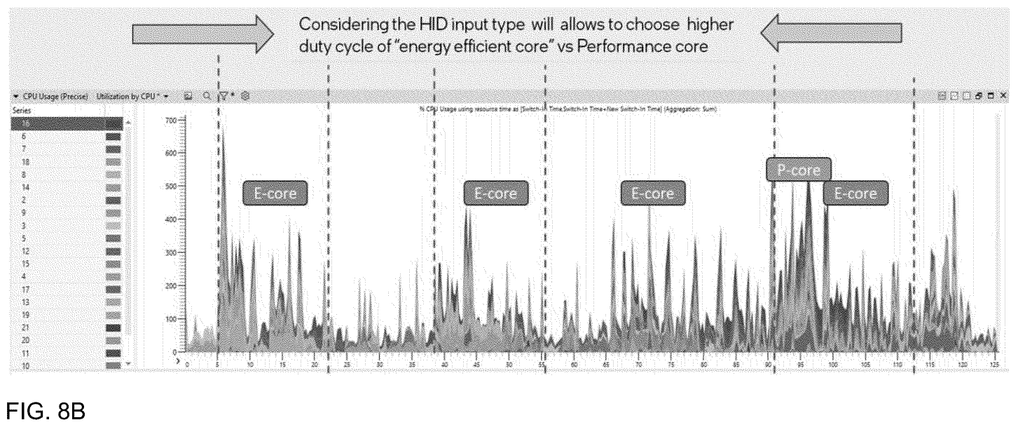

FIGS. 8A and 8B show the experimental validation that was performed using a mouse movement simulation tool during benchmark testing, alongside hands-on trials on the Ultra Core AI-PC. FIGS. 8A and 8B show CPU utilization traces from the experiment without and with implementing the method of power management and scheduling based on HID input types as disclosed herein, respectively. During the experiment, a numerous activities were conducted, such as scrolling and typing in Notepad app, drawing a rectangle in MS Paint app using a mouse, and launching and scrolling in Amazon web page. FIGS. 8A and 8B show that the SoC power consumption increases linearly with increase in HID usages. As shown in FIG. 8A, without considering the user interaction types in power management and scheduling based on user interaction types, in most cases, the activities engage the performance cores (P-cores), leading to an increase in power consumption. In contrast, the experiment result in FIG. 8B shows that considering the HID input type (user interaction type) will allow to choose higher duty cycle of energy efficient core (E-core). FIG. 8A shows that high P-core utilization tends to use more power, and FIG. 8B shows using energy efficient core (E-core) tends to improve battery life.

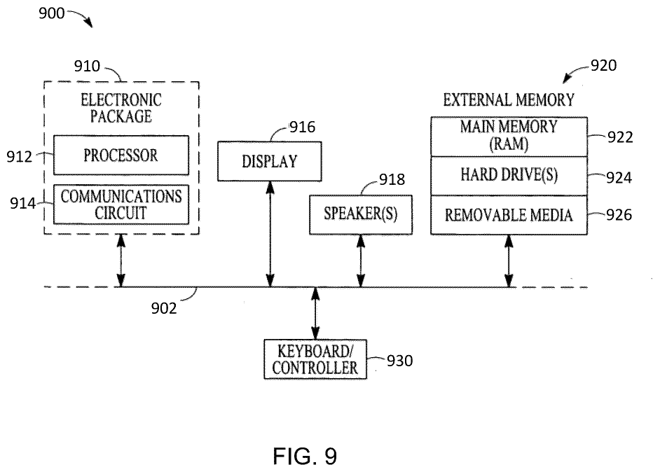

FIG. 9 is a block diagram of an electronic apparatus 900 incorporating at least one electronic assembly and/or method described herein. Electronic apparatus 900 is-merely one example of an electronic apparatus in which forms of the electronic assemblies and/or methods described herein may be used. Examples of an electronic apparatus 900 include, but are not limited to, personal computers, tablet computers, mobile telephones, game devices, MP3 or other digital music players, etc. In this example, electronic apparatus 900 comprises a data processing system that includes a system bus 902 to couple the various components of the electronic apparatus 900. System bus 902 provides communications links among the various components of the electronic apparatus 900 and may be implemented as a single bus, as a combination of busses, or in any other suitable manner.

An electronic assembly 910 as describe herein may be coupled to system bus 902. The electronic assembly 910 may include any circuit or combination of circuits. In one embodiment, the electronic assembly 910 includes a processor 912 which can be of any type. As used herein, “processor” means any type of computational circuit, such as but not limited to a microprocessor, a microcontroller, a complex instruction set computing (CISC) microprocessor, a reduced instruction set computing (RISC) microprocessor, a very long instruction word (VLIW) microprocessor, a graphics processor, a digital signal processor (DSP), multiple core processor, or any other type of processor or processing circuit.

Other types of circuits that may be included in electronic assembly 910 are a custom circuit, an application-specific integrated circuit (ASIC), or the like, such as, for example, one or more circuits (such as a communications circuit 914) for use in wireless devices like mobile telephones, tablet computers, laptop computers, two-way radios, and similar electronic systems. The IC can perform any other type of function.

The electronic apparatus 900 may also include an external memory 920, which in turn may include one or more memory elements suitable to the particular application, such as a main memory 922 in the form of random access memory (RAM), one or more hard drives 924, and/or one or more drives that handle removable media 926 such as compact disks (CD), flash memory cards, digital video disk (DVD), and the like.

The electronic apparatus 900 may also include a display device 916, one or more speakers 918, and a keyboard and/or controller 930, which can include a mouse, trackball, touch screen, voice-recognition device, or any other device that permits a system user to input information into and receive information from the electronic apparatus 900.

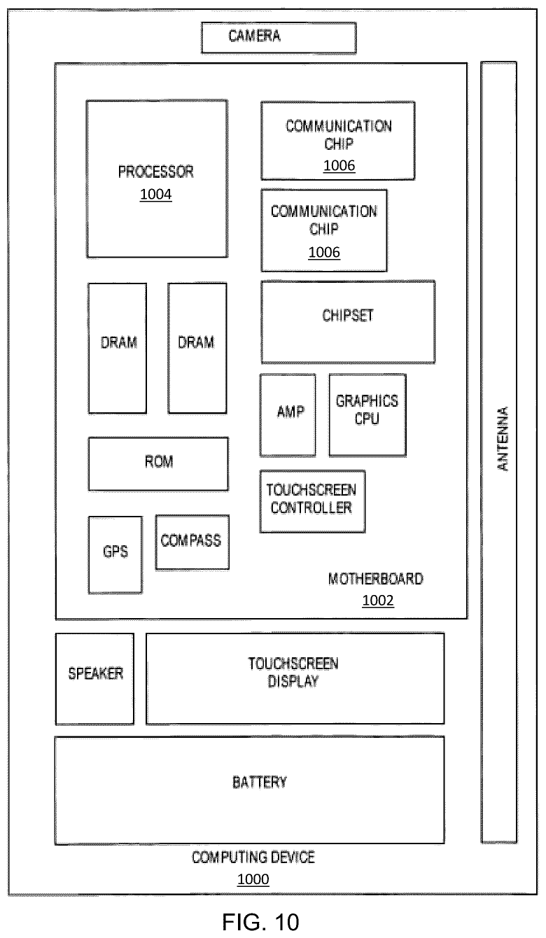

FIG. 10 illustrates a computing device 1000 in accordance with one implementation of the invention. The computing device 1000 houses a board 1002. The board 1002 may include a number of components, including but not limited to a processor 1004 and at least one communication chip 1006. The processor 1004 is physically and electrically coupled to the board 1002. In some implementations the at least one communication chip 1006 is also physically and electrically coupled to the board 1002. In further implementations, the communication chip 1006 is part of the processor 1004. Depending on its applications, computing device 1000 may include other components that may or may not be physically and electrically coupled to the board 1002. These other components include, but are not limited to, volatile memory (e.g., DRAM), non-volatile memory (e.g., ROM), flash memory, a graphics processor, a digital signal processor, a crypto processor, a chipset, an antenna, a display, a touchscreen display, a touchscreen controller, a battery, an audio codec, a video codec, a power amplifier, a global positioning system (GPS) device, a compass, an accelerometer, a gyroscope, a speaker, a camera, and a mass storage device (such as hard disk drive, compact disk (CD), digital versatile disk (DVD), and so forth). The communication chip 1006 enables wireless communications for the transfer of data to and from the computing device 1000. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 1006 may implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. The computing device 1000 may include a plurality of communication chips 1006. For instance, a first communication chip 1006 may be dedicated to shorter range wireless communications such as Wi-Fi and Bluetooth and a second communication chip 1006 may be dedicated to longer range wireless communications such as GPS, EDGE, GPRS, CDMA, WiMAX, LTE, Ev-DO, and others.

The processor 1004 of the computing device 1000 includes an integrated circuit die packaged within the processor 1004. In some implementations of the invention, the integrated circuit die of the processor includes one or more devices that are assembled in an ePLB or eWLB based POP package that that includes a mold layer directly contacting a substrate, in accordance with implementations of the invention. The term “processor” may refer to any device or portion of a device that processes electronic data from registers and/or memory to transform that electronic data into other electronic data that may be stored in registers and/or memory. The communication chip 1006 also includes an integrated circuit die packaged within the communication chip 1006. In accordance with another implementation of the invention, the integrated circuit die of the communication chip includes one or more devices that are assembled in an ePLB or eWLB based POP package that that includes a mold layer directly contacting a substrate, in accordance with implementations of the invention.

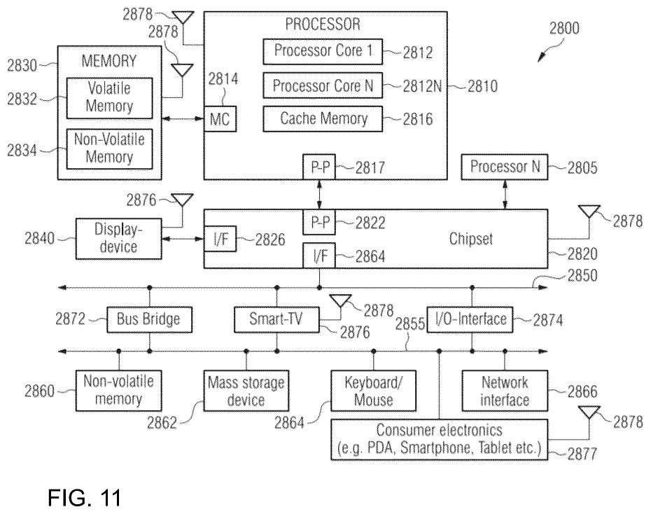

FIG. 11 is included to show an example of a higher-level device application for the disclosed embodiments. The MAA cantilevered heat pipe apparatus embodiments may be found in several parts of a computing system. In an embodiment, the MAA cantilevered heat pipe is part of a communications apparatus such as is affixed to a cellular communications tower. The MAA cantilevered heat pipe may also be referred to as an MAA apparatus. In an embodiment, a computing system 2800 includes, but is not limited to, a desktop computer. In an embodiment, a system 2800 includes, but is not limited to a laptop computer. In an embodiment, a system 2800 includes, but is not limited to a netbook. In an embodiment, a system 2800 includes, but is not limited to a tablet. In an embodiment, a system 2800 includes, but is not limited to a notebook computer. In an embodiment, a system 2800 includes, but is not limited to a personal digital assistant (PDA). In an embodiment, a system 2800 includes, but is not limited to a server. In an embodiment, a system 2800 includes, but is not limited to a workstation. In an embodiment, a system 2800 includes, but is not limited to a cellular telephone. In an embodiment, a system 2800 includes, but is not limited to a mobile computing device. In an embodiment, a system 2800 includes, but is not limited to a smart phone. In an embodiment, a system 2800 includes, but is not limited to an internet appliance. Other types of computing devices may be configured with the microelectronic device that includes MAA apparatus embodiments.

In an embodiment, the processor 2810 has one or more processing cores 2812 and 2812N, where 2812N represents the Nth processor core inside processor 2810 where N is a positive integer. In an embodiment, the electronic device system 2800 using a MAA apparatus embodiment that includes multiple processors including 2810 and 2805, where the processor 2805 has logic similar or identical to the logic of the processor 2810. In an embodiment, the processing core 2812 includes, but is not limited to, pre-fetch logic to fetch instructions, decode logic to decode the instructions, execution logic to execute instructions and the like. In an embodiment, the processor 2810 has a cache memory 2816 to cache at least one of instructions and data for the MAA apparatus in the system 2800. The cache memory 2816 may be organized into a hierarchal structure including one or more levels of cache memory.

In an embodiment, the processor 2810 includes a memory controller 2814, which is operable to perform functions that enable the processor 2810 to access and communicate with memory 2830 that includes at least one of a volatile memory 2832 and a non-volatile memory 2834. In an embodiment, the processor 2810 is coupled with memory 2830 and chipset 2820. The processor 2810 may also be coupled to a wireless antenna 2878 to communicate with any device configured to at least one of transmit and receive wireless signals. In an embodiment, the wireless antenna interface 2878 operates in accordance with, but is not limited to, the IEEE 802.11 standard and its related family, Home Plug AV (HPAV), Ultra Wide Band (UWB), Bluetooth, WiMax, or any form of wireless communication protocol.

In an embodiment, the volatile memory 2832 includes, but is not limited to, Synchronous Dynamic Random Access Memory (SDRAM), Dynamic Random Access Memory (DRAM), RAMBUS Dynamic Random Access Memory (RDRAM), and/or any other type of random access memory device. The non-volatile memory 2834 includes, but is not limited to, flash memory, phase change memory (PCM), read-only memory (ROM), electrically erasable programmable read-only memory (EEPROM), or any other type of non-volatile memory device.

The memory 2830 stores information and instructions to be executed by the processor 2810. In an embodiment, the memory 2830 may also store temporary variables or other intermediate information while the processor 2810 is executing instructions. In the illustrated embodiment, the chipset 2820 connects with processor 2810 via Point-to-Point (PtP or P-P) interfaces 2817 and 2822. Either of these PtP embodiments may be achieved using a MAA apparatus embodiment as set forth in this disclosure. The chipset 2820 enables the processor 2810 to connect to other elements in the MAA apparatus embodiments in a system 2800. In an embodiment, interfaces 2817 and 2822 operate in accordance with a PtP communication protocol such as the Intel® QuickPath Interconnect (QPI) or the like. In other embodiments, a different interconnect may be used.

In an embodiment, the chipset 2820 is operable to communicate with the processor 2810, 2805N, the display device 2840, and other devices 2872, 2876, 2874, 2860, 2862, 2864, 2866, 2877, etc. The chipset 2820 may also be coupled to a wireless antenna 2878 to communicate with any device configured to at least do one of transmit and receive wireless signals.

The chipset 2820 connects to the display device 2840 via the interface 2826. The display 2840 may be, for example, a liquid crystal display (LCD), a plasma display, cathode ray tube (CRT) display, or any other form of visual display device. In and embodiment, the processor 2810 and the chipset 2820 are merged into a MAA apparatus in a system. Additionally, the chipset 2820 connects to one or more buses 2850 and 2855 that interconnect various elements 2874, 2860, 2862, 2864, and 2866. Buses 2850 and 2855 may be interconnected together via a bus bridge 2872 such as at least one MAA apparatus embodiment. In an embodiment, the chipset 2820 couples with a non-volatile memory 2860, a mass storage device(s) 2862, a keyboard/mouse 2864, and a network interface 2866 by way of at least one of the interface 2824 and 2874, the smart TV 2876, and the consumer electronics 2877, etc.

In an embodiment, the mass storage device 2862 includes, but is not limited to, a solid state drive, a hard disk drive, a universal serial bus flash memory drive, or any other form of computer data storage medium. In one embodiment, the network interface 2866 is implemented by any type of well-known network interface standard including, but not limited to, an Ethernet interface, a universal serial bus (USB) interface, a Peripheral Component Interconnect (PCI) Express interface, a wireless interface and/or any other suitable type of interface. In one embodiment, the wireless interface operates in accordance with, but is not limited to, the IEEE 802.11 standard and its related family, Home Plug AV (HPAV), Ultra Wide Band (UWB), Bluetooth, WiMax, or any form of wireless communication protocol.

While the modules shown in FIG. 11 are depicted as separate blocks within the MAA apparatus embodiment in a computing system 2800, the functions performed by some of these blocks may be integrated within a single semiconductor circuit or may be implemented using two or more separate integrated circuits. For example, although cache memory 2816 is depicted as a separate block within processor 2810, cache memory 2816 (or selected aspects of 2816) can be incorporated into the processor core 2812.

Where useful, the computing system 2800 may have a broadcasting structure interface such as for affixing the MAA apparatus to a cellular tower.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions or computer program products as well as any data created and/or used during implementation of the disclosed technologies can be stored on one or more tangible or non-transitory computer-readable storage media, such as volatile memory (e.g., DRAM, SRAM), non-volatile memory (e.g., flash memory, chalcogenide-based phase-change non-volatile memory) optical media discs (e.g., DVDs, CDs), and magnetic storage (e.g., magnetic tape storage, hard disk drives). Computer-readable storage media can be contained in computer-readable storage devices such as solid-state drives, USB flash drives, and memory modules. Alternatively, any of the methods disclosed herein (or a portion) thereof may be performed by hardware components comprising non-programmable circuitry. In some examples, any of the methods herein can be performed by a combination of non-programmable hardware components and one or more processing units executing computer-executable instructions stored on computer-readable storage media.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

As used in this application and the claims, a list of items joined by the term “and/or” can mean any combination of the listed items. For example, the phrase “A, B and/or C” can mean A; B; C; A and B; A and C; B and C; or A, B and C. As used in this application and the claims, a list of items joined by the term “at least one of” can mean any combination of the listed terms. For example, the phrase “at least one of A, B or C” can mean A; B; C; A and B; A and C; B and C; or A, B, and C. Moreover, as used in this application and the claims, a list of items joined by the term “one or more of” can mean any combination of the listed terms. For example, the phrase “one or more of A, B and C” can mean A; B; C; A and B; A and C; B and C; or A, B, and C.

The disclosed methods, apparatuses, and systems are not to be construed as limiting in any way. Instead, the present disclosure is directed toward all novel and nonobvious features and aspects of the various disclosed examples, alone and in various combinations and sub-combinations with one another. The disclosed methods, apparatuses, and systems are not limited to any specific aspect or feature or combination thereof, nor do the disclosed examples require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

Although the operations of some of the disclosed methods are described in a particular, sequential order for convenient presentation, it is to be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods can be used in conjunction with other methods.

Another example is a computer program having a program code for performing at least one of the methods described herein, when the computer program is executed on a computer, a processor, or a programmable hardware component. Another example is a machine-readable storage including machine readable instructions, when executed, to implement a method or realize an apparatus as described herein. A further example is a machine-readable medium including code, when executed, to cause a machine to perform any of the methods described herein.

The examples as described herein may be summarized as follows:

An example (e.g., example 1) relates to a computer-readable medium comprising a program code that, when the program code is executed on a processor, a computer, or a programmable hardware component, causes the processor, the computer, or the programmable hardware component to receive a user input from an HID, determine an HID input type of the user input, provide the HID input type to a power management controller and/or an OS scheduler, and perform power management and/or scheduling based on the HID input type.

Another example, (e.g., example 2) relates to a previously described example (e.g., example 1), wherein the program code is further to adjust an operating frequency of the one or more processor cores based on the HID input type.

Another example, (e.g., example 3) relates to a previously described example (e.g., any one of examples 1-2), wherein the system is a hybrid system including two or more different types of processor cores and the program code is to select one of the two or more different types of processor cores for a task based on the HID input type.

Another example, (e.g., example 4) relates to a previously described example (e.g., example 1), wherein the system includes at least one performance core (P-core) and at least one energy efficiency core (E-core) and the program code is to select a P-core or an E-core for the task depending on the HID input type.

Another example, (e.g., example 5) relates to a previously described example (e.g., any one of examples 1-4), wherein the program code is to set an EPP value for the system, SAGV frequency setting, operating frequency of a memory, and/or allocation of memory units based on the HID input type.

Another example, (e.g., example 6) relates to a previously described example (e.g., any one of examples 1-5), wherein the program code is to update a hardware feedback interface table based on the HID input type.

Another example, (e.g., example 7) relates to a previously described example (e.g., any one of examples 1-6), wherein the program code is to park one or more processor cores in the system based on the HID input type.

Another example, (e.g., example 8) relates to a previously described example (e.g., any one of examples 1-7), wherein the program code is to determine whether a class of service 0 residency is lower than a threshold and/or whether a core concurrency is lower than an E-core count, and perform the power management and/or scheduling based on the HID input type if the class of service 0 residency is lower than the threshold and/or the core concurrency is lower than the E-core count.

Another example, (e.g., example 9) relates to a previously described example (e.g., any one of examples 1-8), wherein the HID input type is indicated to the power management controller or the OS scheduler via PCIe sideband signaling.

Another example, (e.g., example 10) relates to a system configured to perform power management and scheduling based on HID input types. The system includes an HID controller configured to receive a user input from an HID and determine an HID input type of the user input, a power management controller configured to perform power management for the system, and processing circuitry configured to run an OS scheduler, wherein the HID input type is provided to the power management controller and/or the OS scheduler, wherein the power management controller is configured to perform the power management based on the HID input type, and the OS scheduler is configured to perform scheduling based on the HID input type.

Another example, (e.g., example 11) relates to a previously described example (e.g., example 10), wherein an operating frequency of a processor core of the system is adjusted based on the HID input type.

Another example, (e.g., example 12) relates to a previously described example (e.g., any one of examples 10-11), wherein the processing circuitry includes two or more different types of processor cores and one of the processor cores is selected for a task based on the HID input type.

Another example, (e.g., example 13) relates to a previously described example (e.g., example 12), wherein the processing circuitry includes at least one performance core (P-core) and at least one energy efficiency core (E-core) and the task is assigned to a P-core or an E-core depending on the HID input type.

Another example, (e.g., example 14) relates to a previously described example (e.g., any one of examples 10-13), wherein an EPP value for the system, SAGV frequency setting, operating frequency of a memory, and/or allocation of memory units are selected based on the HID input type.

Another example, (e.g., example 15) relates to a previously described example (e.g., any one of examples 10-14), wherein a hardware feedback interface table is updated based on the HID input type.

Another example, (e.g., example 16) relates to a previously described example (e.g., any one of examples 10-15), wherein one or more processor cores in the system are parked based on the HID input type.

Another example, (e.g., example 17) relates to a previously described example (e.g., any one of examples 10-16), wherein the processing circuitry is configured to determine whether a class of service 0 residency is lower than a threshold and/or whether a core concurrency is lower than an E-core count, wherein the power management and/or scheduling is performed based on the HID input type if the class of service 0 residency is lower than the threshold and/or the core concurrency is lower than the E-core count.

Another example, (e.g., example 18) relates to a previously described example (e.g., any one of examples 10-17), wherein the HID input type is indicated to the power management controller or the OS scheduler via PCIe sideband signaling.

Another example, (e.g., example 19) relates to a method for power management and scheduling based on HID input types in a system. The method includes receiving a user input via an HID, determining an HID input type of the user input, providing the HID input type to a power management controller and/or an operating system scheduler, and performing power management and/or scheduling based on the HID input type.

Another example, (e.g., example 20) relates to a previously described example (e.g., example 19), wherein an operating frequency of one or more processor cores of the system is adjusted based on the HID input type, or the system is a hybrid system including two or more different types of processor cores and one of the two or more different types of processor cores is selected for a task based on the HID input type, or an EPP value for the system, SAGV frequency setting, operating frequency of a memory, and/or allocation of memory units is set based on the HID input type, or a hardware feedback interface table is updated based on the HID input type, or one or more processor cores in the system is parked based on the HID input type.

The aspects and features mentioned and described together with one or more of the previously detailed examples and figures, may as well be combined with one or more of the other examples in order to replace a like feature of the other example or in order to additionally introduce the feature to the other example.

Examples may further be or relate to a computer program having a program code for performing one or more of the above methods, when the computer program is executed on a computer or processor. Steps, operations or processes of various above-described methods may be performed by programmed computers or processors. Examples may also cover program storage devices such as digital data storage media, which are machine, processor or computer readable and encode machine-executable, processor-executable or computer-executable programs of instructions. The instructions perform or cause performing some or all of the acts of the above-described methods. The program storage devices may comprise or be, for instance, digital memories, magnetic storage media such as magnetic disks and magnetic tapes, hard drives, or optically readable digital data storage media. Further examples may also cover computers, processors or control units programmed to perform the acts of the above-described methods or (field) programmable logic arrays ((F)PLAs) or (field) programmable gate arrays ((F)PGAs), programmed to perform the acts of the above-described methods.

The description and drawings merely illustrate the principles of the disclosure. Furthermore, all examples recited herein are principally intended expressly to be only for pedagogical purposes to aid the reader in understanding the principles of the disclosure and the concepts contributed by the inventor(s) to furthering the art. All statements herein reciting principles, aspects, and examples of the disclosure, as well as specific examples thereof, are intended to encompass equivalents thereof.

A functional block denoted as “means for . . . ” performing a certain function may refer to a circuit that is configured to perform a certain function. Hence, a “means for s.th.” may be implemented as a “means configured to or suited for s.th.”, such as a device or a circuit configured to or suited for the respective task.

Functions of various elements shown in the figures, including any functional blocks labeled as “means”, “means for providing a sensor signal”, “means for generating a transmit signal.”, etc., may be implemented in the form of dedicated hardware, such as “a signal provider”, “a signal processing unit”, “a processor”, “a controller”, etc. as well as hardware capable of executing software in association with appropriate software. When provided by a processor, the functions may be provided by a single dedicated processor, by a single shared processor, or by a plurality of individual processors, some of which or all of which may be shared. However, the term “processor” or “controller” is by far not limited to hardware exclusively capable of executing software but may include digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included.

A block diagram may, for instance, illustrate a high-level circuit diagram implementing the principles of the disclosure. Similarly, a flow chart, a flow diagram, a state transition diagram, a pseudo code, and the like may represent various processes, operations or steps, which may, for instance, be substantially represented in computer readable medium and so executed by a computer or processor, whether or not such computer or processor is explicitly shown. Methods disclosed in the specification or in the claims may be implemented by a device having means for performing each of the respective acts of these methods.

It is to be understood that the disclosure of multiple acts, processes, operations, steps or functions disclosed in the specification or claims may not be construed as to be within the specific order, unless explicitly or implicitly stated otherwise, for instance for technical reasons. Therefore, the disclosure of multiple acts or functions will not limit these to a particular order unless such acts or functions are not interchangeable for technical reasons. Furthermore, in some examples a single act, function, process, operation or step may include or may be broken into multiple sub-acts, -functions, -processes, -operations or -steps, respectively. Such sub acts may be included and part of the disclosure of this single act unless explicitly excluded.

Furthermore, the following claims are hereby incorporated into the detailed description, where each claim may stand on its own as a separate example. While each claim may stand on its own as a separate example, it is to be noted that—although a dependent claim may refer in the claims to a specific combination with one or more other claims—other examples may also include a combination of the dependent claim with the subject matter of each other dependent or independent claim. Such combinations are explicitly proposed herein unless it is stated that a specific combination is not intended. Furthermore, it is intended to include also features of a claim to any other independent claim even if this claim is not directly made dependent to the independent claim.

1. A computer-readable medium comprising a program code that, when the program code is executed on a processor, a computer, or a programmable hardware component, causes the processor, the computer, or the programmable hardware component to:
receive a user input from a human interface device (HID);
determine an HID input type of the user input;
provide the HID input type to a power management controller and/or an operating system (OS) scheduler; and
perform power management and/or scheduling based on the HID input type.

2. The computer-readable medium of claim 1, wherein the program code is further to adjust an operating frequency of the one or more processor cores based on the HID input type.

3. The computer-readable medium of claim 1, wherein the system is a hybrid system including two or more different types of processor cores and the program code is to select one of the two or more different types of processor cores for a task based on the HID input type.

4. The computer-readable medium of claim 3, wherein the system includes at least one performance core (P-core) and at least one energy efficiency core (E-core) and the program code is to select a P-core or an E-core for the task depending on the HID input type.

5. The computer-readable medium of claim 1, wherein the program code is to set an energy performance preference (EPP) value for the system, System Agent Geyserville (SAGV) frequency setting, operating frequency of a memory, and/or allocation of memory units based on the HID input type.

6. The computer-readable medium of claim 1, wherein the program code is to update a hardware feedback interface table based on the HID input type.

7. The computer-readable medium of claim 1, wherein the program code is to park one or more processor cores in the system based on the HID input type.

8. The computer-readable medium of claim 1, wherein the program code is to:
determine whether a class of service 0 residency is lower than a threshold and/or whether a core concurrency is lower than an E-core count; and
perform the power management and/or scheduling based on the HID input type if the class of service 0 residency is lower than the threshold and/or the core concurrency is lower than the E-core count.

9. The computer-readable medium of claim 1, wherein the HID input type is indicated to the power management controller or the OS scheduler via PCIe sideband signaling.

10. A system configured to perform power management and scheduling based on human interface device (HID) input types, comprising:
an HID controller configured to receive a user input from an HID and determine an HID input type of the user input;
a power management controller configured to perform power management for the system; and
processing circuitry configured to run an operating system (OS) scheduler, wherein the HID input type is provided to the power management controller and/or the OS scheduler,
wherein the power management controller is configured to perform the power management based on the HID input type, and the OS scheduler is configured to perform scheduling based on the HID input type.

11. The system of claim 10, wherein an operating frequency of a processor core of the system is adjusted based on the HID input type.

12. The system of claim 10, wherein the processing circuitry includes two or more different types of processor cores and one of the processor cores is selected for a task based on the HID input type.

13. The system of claim 12, wherein the processing circuitry includes at least one performance core (P-core) and at least one energy efficiency core (E-core) and the task is assigned to a P-core or an E-core depending on the HID input type.

14. The system of claim 10, wherein an energy performance preference (EPP) value for the system, System Agent Geyserville (SAGV) frequency setting, operating frequency of a memory, and/or allocation of memory units are selected based on the HID input type.

15. The system of claim 10, wherein a hardware feedback interface table is updated based on the HID input type.

16. The system of claim 10, wherein one or more processor cores in the system are parked based on the HID input type.

17. The system of claim 10, wherein the processing circuitry is configured to determine whether a class of service 0 residency is lower than a threshold and/or whether a core concurrency is lower than an E-core count,
wherein the power management and/or scheduling is performed based on the HID input type if the class of service 0 residency is lower than the threshold and/or the core concurrency is lower than the E-core count.

18. The system of claim 10, wherein the HID input type is indicated to the power management controller or the OS scheduler via PCIe sideband signaling.

19. A method for power management and scheduling based on human interface device (HID) input types in a system, comprising:
receiving a user input via an HID;
determining an HID input type of the user input;
providing the HID input type to a power management controller and/or an operating system scheduler; and
performing power management and/or scheduling based on the HID input type.

20. The method of claim 19,
wherein an operating frequency of one or more processor cores of the system is adjusted based on the HID input type, or
wherein the system is a hybrid system including two or more different types of processor cores and one of the two or more different types of processor cores is selected for a task based on the HID input type, or
wherein an energy performance preference (EPP) value for the system, System Agent Geyserville (SAGV) frequency setting, operating frequency of a memory, and/or allocation of memory units is set based on the HID input type, or
wherein a hardware feedback interface table is updated based on the HID input type, or
wherein one or more processor cores in the system is parked based on the HID input type.
